(19) United States
(12) Patent Application Publication
(10) Pub. No.: US 2017/0192941 A1
(43) Pub. Date: Jul. 6, 2017

(54) Computer-Automated Generation of Application Deep Links

(71) Applicant: Quixey, Inc., Mountain View, CA (US)

(72) Inventors: Eric GLOVER, Palo Alto, CA (US); Mark ROBINSON, Union City, CA (US); Leigh KLOTZ, JR., Palo Alto, CA (US); Kalyan DESINENI, Mountain View, CA (US)

(21) Appl. No.: 15/399,621

(22) Filed: Jan. 5, 2017

Related U.S. Application Data
(60) Provisional application No. 62/315,617, filed on Mar. 30, 2016.
(60) Provisional application No. 62/275,200, filed on Jan. 5, 2016.

(51) Int. Cl. G06F 17/22; H04L 29/12; G06F 17/24; H04L 29/08

(52) U.S. Cl. CPC G06F 17/2235; H04L 67/02; H04L 61/1582; G06F 17/247

(57) ABSTRACT

A computerized link generation system includes a webpage data acquisition module that receives a first web URL from a link requesting device and requests webpage data from the specified web server. From the webpage data, access data and rendering data is extracted, including a text string and an image. Each stored access mechanism template includes web URL matching data and a set of parameter types. The access mechanism generation module generates a first access mechanism by populating a selected access mechanism template with the extracted access data based on a mapping of the extracted access data to the set of parameter types. The first access mechanism invokes specific functionality of a native application. A rendering module arranges the display of the extracted rendering data. A transmission device provides the first access mechanism with the arranged extracted rendering data to the link requesting device.

### CROSS-REFERENCE TO RELATED APPLICATIONS

This application claims the benefit of U.S. Provisional Application No. 62/315,617, filed on Mar. 30, 2016 and U.S. Provisional Application No. 62/275,200, filed on Jan. 5, 2016. The entire disclosures of the applications referenced above are incorporated by reference.

### FIELD

The present disclosure relates to generating links and, more particularly, to generating links that access native application functionality.

### BACKGROUND

In recent years, use of computers, smartphones, and other internet-connected devices has grown. Correspondingly, the number of available software applications for such devices has also grown. Many diverse native and web software applications can be accessed on any number of different devices, including, but not limited to, smartphones, personal computers, automobiles, and televisions. In some cases, software developers can provide content through both a website and a native application. The website content may be accessible via a web browser using web uniform resource locators (URLs). In some cases, native application content can be directly accessed in a native application using an application resource identifier (e.g., provided by a developer).

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A computerized link generation system includes a webpage data acquisition module configured to (i) receive a first web URL from a link requesting device and (ii) request webpage data from a server specified by the first web URL. The computerized link generation system includes a metadata extraction module configured to extract access data and rendering data from the webpage data. The extracted rendering data includes at least one text string and at least one image. The computerized link generation system includes an access mechanism template data store configured to store access mechanism templates. Each access mechanism template includes web URL matching data and a set of parameter types. The computerized link generation system includes an access mechanism generation module configured to select one of the access mechanism templates according to a comparison between the first web URL and the web URL matching data of the access mechanism templates. The access mechanism generation module is configured to generate a first access mechanism by populating the selected access mechanism template with the extracted access data based on a mapping of the extracted access data to the set of parameter types. The first access mechanism invokes specific functionality of at least one of a native edition of an application and a web edition of an application. The computerized link generation system includes a rendering data store configured to store rendering records. Each of the rendering records dictates how to arrange display data associated with an access mechanism. The computerized link generation system includes a rendering data generation module configured to select one of the rendering records and generate link rendering data with the extracted rendering data according to the selected rendering record. The computerized link generation system includes a transmission device configured to provide the first access mechanism and the link rendering data to the link requesting device. User actuation of the link rendering data on a user device is configured to invoke the first access mechanism.

In other features, the transmission device is a local area network transceiver. In other features, the one of the rendering records includes a display layout and defined locations within the layout to be populated by at least a portion of the extracted rendering data. In other features, for each access mechanism template of the access mechanism templates, the web URL matching data includes a string. In other features, for each access mechanism template of the access mechanism templates, the web URL matching data includes a criterion indicating how closely the string must be matched.

In other features, the extracted access data includes a set of pairs. Each pair includes a value and a type identifier. In other features, the access mechanism generation module is configured to select the one of the access mechanism templates according to a similarity between the set of parameter types and the type identifiers of the extracted access data. In other features, the access mechanism generation module is configured to select multiple of the access mechanism templates in response to each access mechanism template of the access mechanism templates for which the set of parameter types is a subset of the type identifiers of the extracted access data. In other features, the link requesting device is one of the user device and a server configured to store the first access mechanism and the link rendering data until a request is received from the user device.

In other features, the metadata extraction module is configured to selectively resize and resample the at least one image. In other features, the first access mechanism is a string. In other features, the access mechanism template data store is configured to store access mechanism templates is configured to store extraction rules, each of the extraction rules corresponds to a respective native application and specifies a format for at least one type of data for the respective native application, and the metadata extraction module is configured to extract the rendering data from the webpage data according to at least one of the stored extraction rules.

A method of computerized link generation includes receiving a first web URL from a link requesting device. The method includes requesting webpage data from a server specified by the first web URL. The method includes extracting access data and rendering data from the webpage data. The extracted rendering data includes at least one text string and at least one image. The method includes storing access mechanism templates. Each access mechanism template includes web URL matching data and a set of parameter types. The method includes selecting one of the access mechanism templates according to a comparison between the first web URL and the web URL matching data of the access mechanism templates. The method includes generating a first access mechanism by populating the selected access mechanism template with the extracted access data based on a mapping of the extracted access data to the set of parameter types. The first access mechanism invokes specific functionality of at least one of a native edition of an application and a web edition of an application. The method includes storing rendering records. Each of the rendering records dictates how to arrange display data associated with an access mechanism. The method includes selecting one of the rendering records and generate link rendering data with the extracted rendering data according to the selected rendering record. The method includes providing the first access mechanism and the link rendering data to the link requesting device. User actuation of the link rendering data on a user device is configured to invoke the first access mechanism.

In other features, the one of the rendering records includes a display layout and defined locations within the layout to be populated by at least a portion of the extracted rendering data. In other features, for each access mechanism template of the access mechanism templates, the web URL matching data includes a string. In other features, for each access mechanism template of the access mechanism templates, the web URL matching data includes a criterion indicating how closely the string must be matched. In other features, the extracted access data includes a set of pairs. Each pair includes a value and a type identifier.

In other features, the selecting the one of the access mechanism templates is performed according to a similarity between the set of parameter types and the type identifiers of the extracted access data. In other features, the method includes selecting multiple of the access mechanism templates in response to each access mechanism template of the access mechanism templates for which the set of parameter types is a subset of the type identifiers of the extracted access data. In other features, the method includes selectively resizing and resampling the at least one image. In other features, the method includes storing extraction rules. Each of the extraction rules corresponds to a respective native application and specifies a format for at least one type of data for the respective native application. The extracting the rendering data is performed according to at least one of the extraction rules.

A computer-readable medium includes instructions for execution on processing hardware. The instructions include receiving a web uniform resource locator (URL) from a link requesting device, the web URL specifying a location of a web resource that is accessible via a web browser application. The instructions include retrieving webpage data from the web resource using the web URL. The instructions include generating access mechanism metadata from the webpage data, the access mechanism metadata including a list of extracted values, each of which is associated with an extracted value type that indicates the type of the extracted value. The instructions include identifying an initial set of template records in a template data store based on the web URL, each of the template records including an access mechanism template having a set of template parameters. Each template parameter is associated with a respective template parameter type. Each of the template records further includes template completion instructions indicating how to generate an application access mechanism from the access mechanism template. The application access mechanism accesses a native application state including content corresponding to the web resource. The instructions include selecting a template record from the initial set of template records based on matches between the extracted value types and the template parameter types included in the selected template record. The instructions include generating an application access mechanism using the extracted values and the access mechanism template and template completion instructions included in the selected template record. The instructions include generating link rendering data based on the webpage data. The link rendering data represents the native application state accessed using the generated application access mechanism. The link rendering data is formatted for display on a user device. The instructions include transmitting the generated application access mechanism and the link rendering data to the link requesting device.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 illustrates an environment including link requesting devices, a link generation system, and a plurality of web servers in communication via a network.

FIG. 2 illustrates an example link requesting device in communication with a link generation system.

FIG. 3 is a functional block diagram of an example link generation system.

FIG. 4 illustrates a method for generating access mechanisms and link rendering data for a web uniform resource locator.

FIG. 5A is a functional block diagram of a metadata extraction module, an access mechanism generation module, and an access mechanism template data store.

FIG. 5B illustrates an example access mechanism template record.

FIG. 6 illustrates a method for generating one or more access mechanisms.

FIG. 7A is a function block diagram of a metadata extraction module, a rendering data generation module, and a rendering data store.

FIG. 7B illustrates an example rendering record.

FIG. 8 illustrates a method for generating link rendering data.

FIG. 9 illustrates an environment in which an advertisement system communicates with a link generation system.

FIG. 10 illustrates an example advertiser device in communication with an advertisement system.

In the drawings, reference numbers may be reused to identify similar and/or identical elements.

### DETAILED DESCRIPTION

A user device (e.g., a smartphone) may have multiple native applications installed. For example, the user device may include an installed web browser application that can be used to access webpages using web uniform resource locators (web URLs). The user device may also include a plurality of additional installed native applications developed by a variety of different software developers. The user device can use application access mechanisms (hereinafter “access mechanisms”) to access different states of the installed native applications. A state of a native application (i.e., an application state) may generally refer to a page/screen of the native application.

Software developers may develop websites and corresponding native applications that provide similar functionality and content. For example, such corresponding websites and native applications may include webpages and application states that include similar content. In a more specific example, a developer may develop a restaurant review website including webpages that provide restaurant reviews (e.g., one restaurant per webpage). In this example, the developer may also develop a native application in which application states provide restaurant reviews (e.g., one restaurant per application state). In another specific example, a developer that provides a video streaming service may develop a website and native application that provide similar functionality (e.g., movie/TV playback) and content (e.g., movies and television shows). In this example, different webpages and application states of the website and native application may play back the same/similar television shows and movies.

In some cases, the web URLs and access mechanisms for corresponding webpages and application states are provided by the developer or in some other manner (e.g., embedded on a webpage). In these cases, a user device can select whether to access corresponding webpages and application states using either the web browser or an installed native application. In other cases, access mechanisms for accessing application states that correspond to webpages may not be readily available (e.g., provided by a developer or embedded on a webpage).

A link generation system of the present disclosure can automatically generate access mechanisms for accessing application states corresponding to webpages. The link generation system can also generate link rendering data for rendering a displayed link on a user device that may be representative of the application state accessed by the generated access mechanism. A displayed link including an underlying access mechanism may be referred to herein as an “application link.” A user may select (e.g., click or touch) an application link to access the application state specified by the underlying access mechanism. In some implementations, an application link may be an underlined text link (e.g., a hyperlink). In other implementations, application links may include additional text and/or images that are descriptive of the application state accessed by selecting the application link.

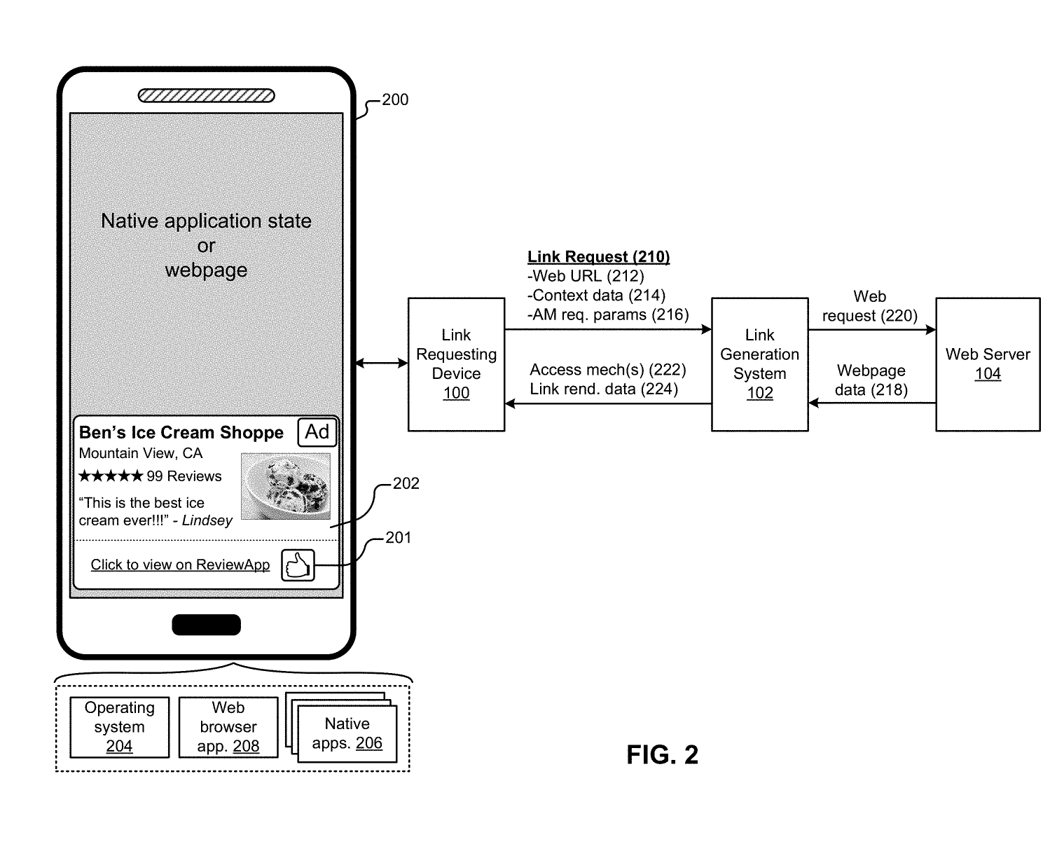

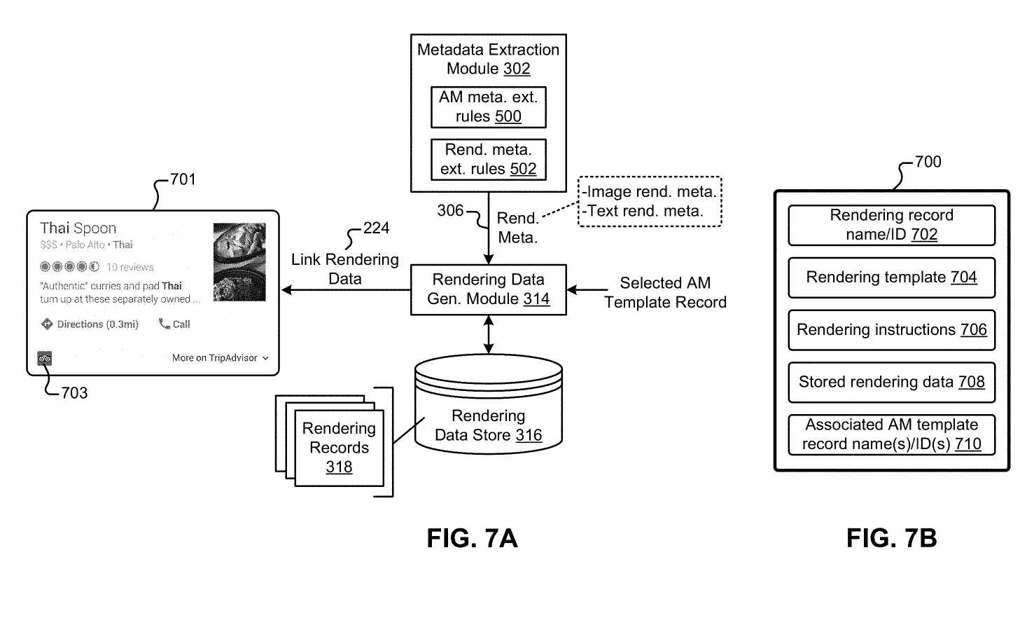

Some application links are in the form of cards including text/images that represent the application state accessed by selecting the application link (e.g., application links 202, 701 of FIGS. 2 and 7A, respectively). For example, a card can include a boundary (e.g., a line) surrounding the text/images and interface elements (e.g., buttons/links) that represent the application state accessed via selection of the card.

A link generation system of the present disclosure receives a web URL from a link requesting device and acquires webpage data (e.g., static and/or dynamic webpage data) using the web URL. For example, the webpage data may include a web document (e.g., a document including HTML) that a web browser application can use to render a webpage. The link generation system can then generate an access mechanism and link rendering data using the acquired webpage data. The access mechanism can be used by a user device (e.g., a smartphone) to access a native application state corresponding to the webpage accessed by the web URL. The link rendering data can be used by a user device to render application links that represent the webpage and/or application state accessed using the web URL and/or generated access mechanism.

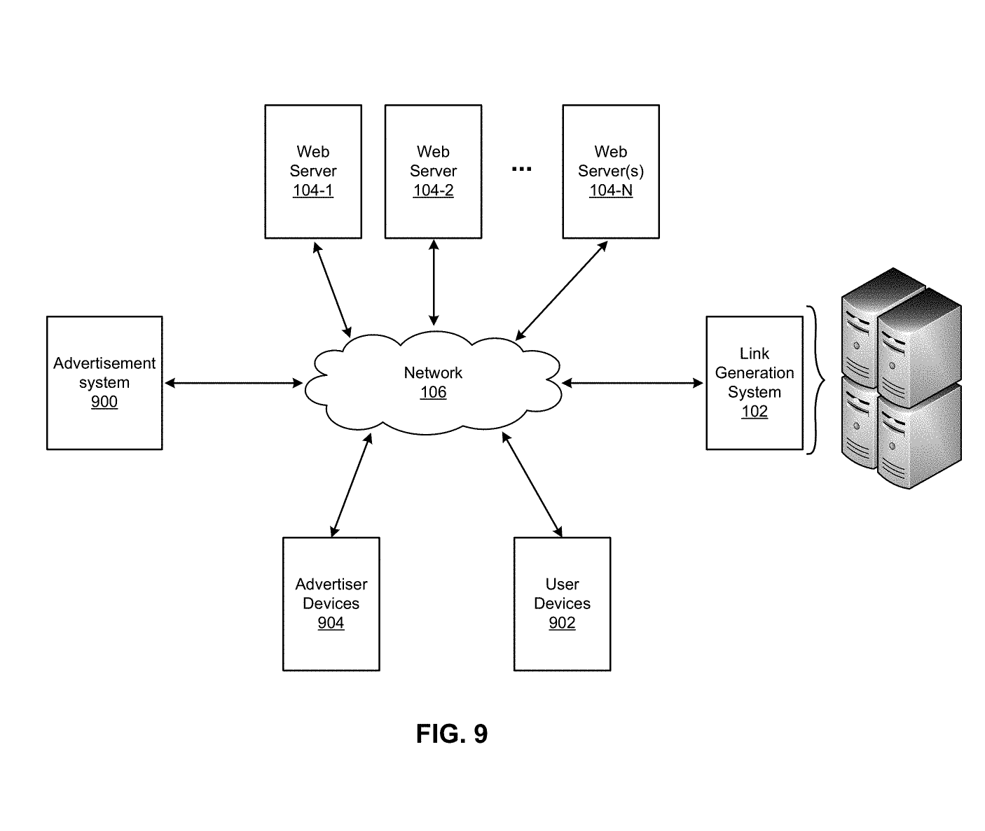

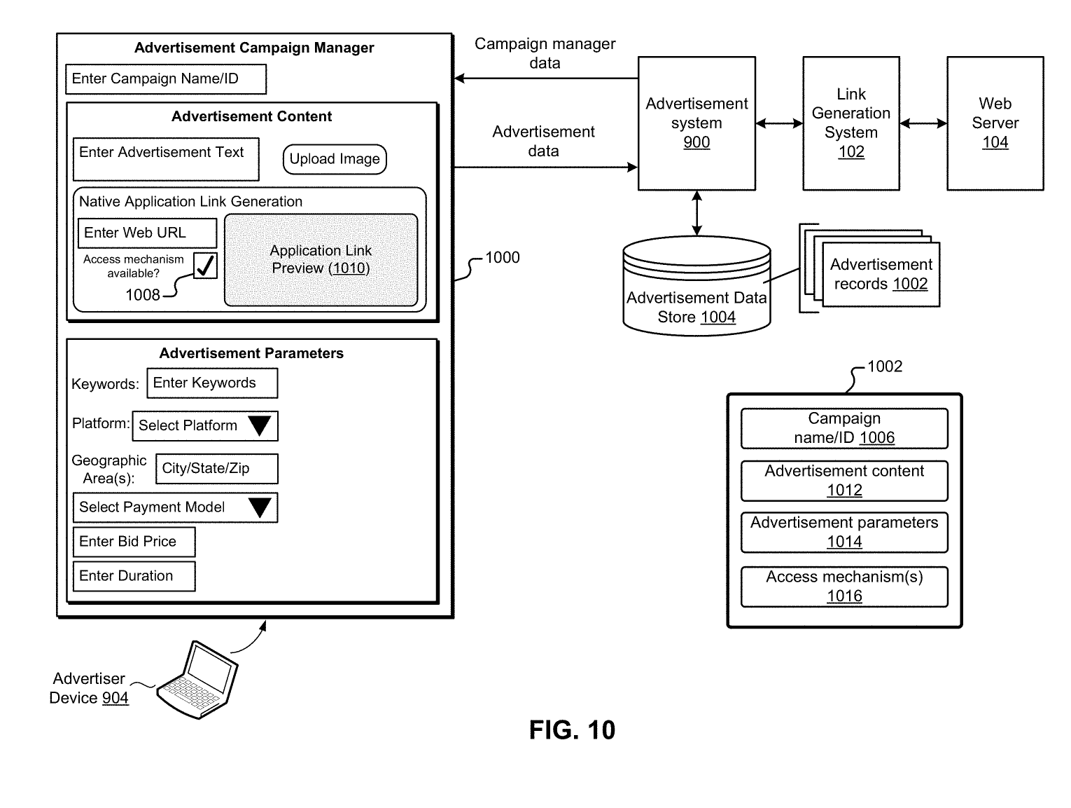

The application links (e.g., cards) can be included in a variety of different locations, such as on webpages and/or in native application states. In some implementations (e.g., FIGS. 9-10), advertisement systems (e.g., advertising networks) may implement the link generation system or use the services of the link generation system in order to generate advertisements that can access native application states. In these examples, the application links may include advertisements that are included in webpages and/or application states.

As described herein, the link generation system can automatically provide access mechanisms and link rendering data for generating application links that a user device can open in a web browser and/or native application, depending on the user's preferences and native application installation status (e.g., installed or not installed). Automatically providing access mechanisms and link rendering data may allow users to access application states that may not otherwise have been supported via previously existing web URLs. Furthermore, automatically providing the access mechanisms and link rendering data using the link generation system may remove the burden on the developers of generating the access mechanisms and/or rendering data in the case that the developer may not have the resources or understanding to generate such data. When implemented by an advertisement system, the additional application links including access mechanisms may help drive reengagement with developers' native applications and provide a positive user experience for those users having an installed native application that can be accessed using the access mechanism.

Link rendering data may be displayed in the form of deep view cards (DVCs). A DVC for an app or a state of an app shows additional information beyond just the identification of the app or app state. For example, the information may include a title of the app state or a description of the app state, which may be a snippet of text from the app state. Other metadata may be provided from the app state, including images, location, number of reviews, average review, and status indicators. For example, a status indicator of “open now” or “closed” may be applied to a business depending on whether the current time is within the operating hours of the business.

Some DVCs may emphasize information that led to the DVC being selected as a search result. For example, text within the DVC that matches a user's query may be shown in bold or italics. The DVC may also incorporate elements that allow direct actions, such as the ability to immediately call an establishment or to transition directly to a mapping app to get navigation directions to the establishment.

Other interactions with the DVC (such as tapping or clicking any other area of the DVC) may take the user to the indicated state or app. As described in more detail below, this may be accomplished by opening the relevant app or, if the app is not installed, opening a website related to the desired app state. In other implementations, an app that is not installed may be downloaded, installed, and then executed in order to reach the desired app state.

In other words, a DVC includes identifying information for the app or state as well as additional content from the app or state itself. The additional content allows the user to make a more informed choice about which result to choose, and may even allow the user to directly perform an action without having to navigate to the app state. If the action the user wants to take is to obtain information, in some circumstances the DVC itself may provide the necessary information to accomplish such action.

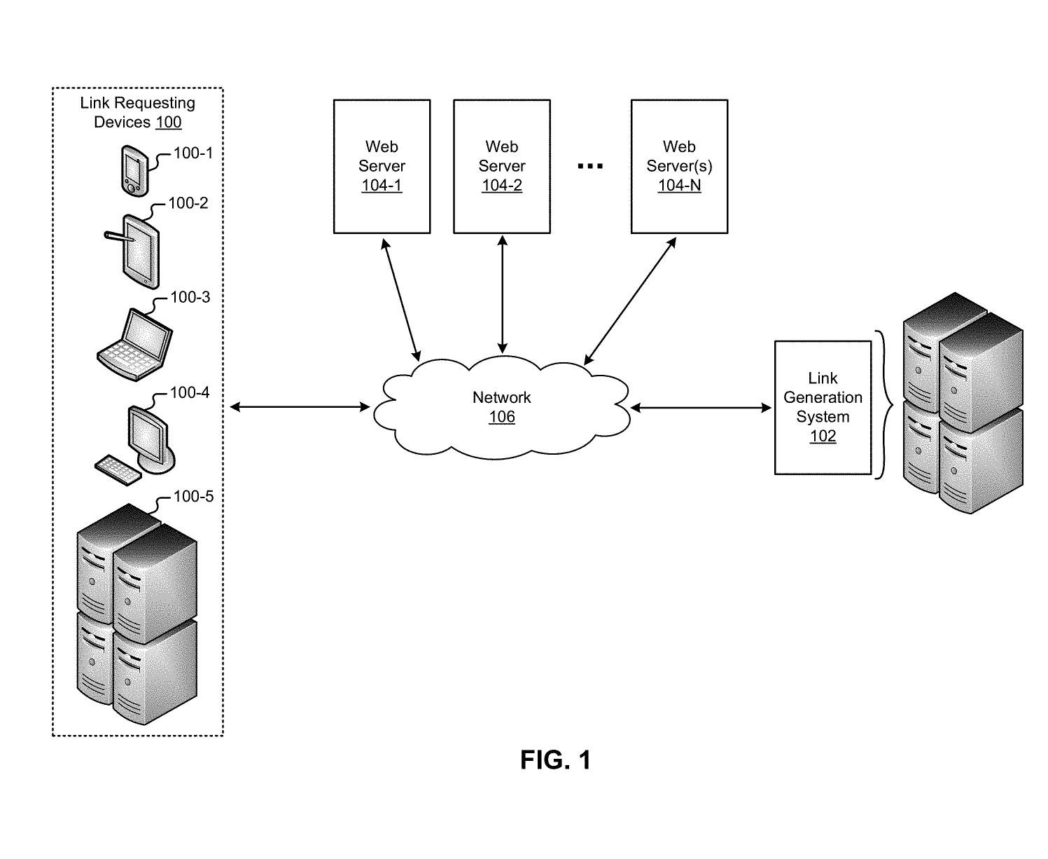

FIG. 1 illustrates an environment that includes link requesting devices 100, a link generation system 102, and a plurality of web servers 104-1, 104-2, . . . , 104-N (collectively “web servers 104”). The link requesting devices 100, link generation system 102, and web servers 104 can communicate with one another via a network 106. The network 106 may include various types of networks, such as a local area network (LAN), wide area network (WAN), and/or the internet.

The link requesting devices 100 can request access mechanisms and/or link rendering data from the link generation system 102. The link requesting devices 100 may include a variety of different computing devices, including, but not limited to, user devices such as a handheld computing device (e.g., a smartphone 100-1 or tablet 100-2), a laptop computing device 100-3, and a desktop computing device 100-4. In some cases, a link requesting device 100 can be a computing device that is part of a system of one or more computing devices (e.g., computing device 100-5 of FIG. 1). For example, the link requesting device 100 may be a server computing device that is part of a group of server computing devices. In a more specific example, a link requesting device 100 may be an advertisement system (e.g., an advertising network) that requests access mechanisms and/or link rendering data for generating advertisements to be rendered as application links on user devices. An example advertisement system is described with reference to FIGS. 9-10.

The link requesting device 100 may use the data received from the link generation system 102 upon receipt of the data from the link generation system 102. For example, if the link requesting device 100 is a user device (e.g., a smartphone, tablet, laptop, or desktop), and the link requesting device 100 receives an access mechanism, the link requesting device 100 may incorporate the access mechanism into a rendered application link. If the link requesting device 100 also receives link rendering data from the link generation system 102, the link requesting device 100 can render the application link based on the received link rendering data.

In some cases, the link requesting device 100 may store the data received from the link generation system 102. At a later time, the link requesting device 100 may transmit the data (e.g., access mechanisms and/or link rendering data) to another device. For example, if the link requesting device 100 is a server (e.g., an advertising network server), the link requesting device 100 may transmit the data to a user device in response to a request from the user device. In a specific example illustrated in FIG. 9, the advertisement system 900 may store access mechanisms and/or link rendering data received from the link generation system 102 and then may later transmit the access mechanisms and/or link rendering data as an advertisement to be displayed on a user device.

The web servers 104 may include systems of computing devices that deliver web content to user devices. For example, user devices running web browser applications can retrieve webpage data (e.g., HTML documents including images, text, scripts, etc.) from the web servers 104 using web URLs. The web servers 104 represent a plurality of servers that deliver webpage data from different web domains. The different web domains may have corresponding native applications so that webpages included in the different domains have corresponding application states. Native applications may also request data from servers during operation. In some implementations, the same servers may deliver webpage data to web browsers and native application data to native applications. In other implementations, the servers that deliver the webpage data and the native application data may be different.

FIG. 2 illustrates example communications between a user device 200 (e.g., a smartphone), a link requesting device 100, the link generation system 102, and a web server 104. In FIG. 2, the link requesting device 100 may represent a computing system that delivers advertisements to user devices. Accordingly, in FIG. 2, the link requesting device 100 may include received access mechanisms and/or link rendering data in an advertisement stored at the link requesting device 100. The link requesting device 100 may store the advertisements and transmit the advertisements to the user device 200 at a later time to be rendered as application links. Although the link requesting device 100 is described as an advertisement system in FIG. 2, other types of computing systems (e.g., other than advertisement systems) may perform similar functionality (e.g., delivering application links to user devices).

An example application link 202 (e.g., a card) is rendered on the user device 200 of FIG. 2. The example application link 202 is an advertisement for a fictional store named “Ben's Ice Cream Shoppe.” The application link 202 may be associated with an underlying web URL and an underlying access mechanism received from the link requesting device 100 along with link rendering data used to render the application link 202. The user device 202 may use the web URL and access mechanism to access web and native application functionality. For example, selection (e.g., click or touch) of the application link 202 may cause the user device 202 to open the application state for Ben's Ice Cream Shoppe in the ReviewApp if the user device has the ReviewApp native application installed. If the ReviewApp native application is not installed, then the user device 202 may open the webpage for Ben's Ice Cream Shoppe.

In general, a user device may refer to a computing device (e.g., a consumer electronics device) that a person can use to access web and/or native application content. For example, a user device can include networking hardware that acquires web and/or native application content via a computer network (e.g., network 106). A user device can also include user interface devices for interacting with web and/or native application content, such as a display and user input components (e.g., a keyboard, mouse, touchscreen, etc.). Example user devices include, but are not limited to, smart phones, tablet computers, laptop computers, and desktop computers. User devices may also include other computing devices having other form factors, such as computing devices included in vehicles, gaming devices, televisions, or other appliances (e.g., networked home automation devices and home appliances). User devices may use a variety of different operating systems (e.g., illustrated at 204 in FIG. 2). In an example where a user device is a mobile device, the user device may run an operating system including, but not limited to, ANDROID® developed by Google Inc. or IOS® developed by Apple Inc. In an example where a user device is a laptop or desktop computing device, the user device may run an operating system including, but not limited to, MICROSOFT WINDOWS® by Microsoft Corporation, MAC OS® by Apple, Inc., or Linux.

User devices may have a plurality of installed native applications (e.g., illustrated at 206 in FIG. 2). In some examples, native applications may function without communication with other remote computing devices (e.g., via the Internet). In other examples, a native application installed on a user device may access information from other remote computing devices during operation. For example, a weather application installed on a user device may access the latest weather information via the Internet and display the accessed weather information to the user through the installed weather application. A user device may also include a native application for browsing webpages (e.g., web browser application 208 of FIG. 2), such as static/dynamic webpages including, but not limited to, web-based email, online auctions, and online retail sites. User devices may download native applications from digital distribution platforms (not illustrated) and subsequently install the native applications. Example digital distribution platforms include, but are not limited to, the GOOGLE PLAY® digital distribution platform by Google, Inc. and the APP STORE® digital distribution platform by Apple, Inc.

Example communications illustrated in FIG. 2 are now described. Initially, the link requesting device 100 may transmit a link request 210 to the link generation system 102. The link request 210 may include a web URL 212. In some implementations, the link request 210 may also include context data 214 and/or access mechanism (AM) request parameters 216. The web URL 212 may indicate a webpage for which a corresponding access mechanism and/or link rendering data is being requested (e.g., for generation of an application link). The web URL 212 may include a mobile/desktop web URL that can be used by a web browser application to access a web resource (e.g., webpage data) on a web server. In some cases, the web URL destination may be an advertisement. In some cases, the web URL may be a redirect that directs to another web address.

The context data 214 may include a variety of different types of data that are descriptive of the link requesting device 100. If the link requesting device 100 is a user device, the context data 214 can include data describing the platform of the user device, such as the operating system (OS) of the user device, a device type (e.g., smartphone type, tablet type, manufacturer, etc.), the version of the web browser application(s) on the user device, and the edition(s) of the native application(s) installed on the user device. In some cases, the context data 214 can include the geolocation of the user device (e.g., as determined by a global positioning system receiver included in the user device). In some implementations, the link generation system 102 may generate access mechanisms based on the context data 214. For example, the link generation system 102 can generate one or more access mechanism(s) that are compatible with the platform of the user device.

The AM request parameters 216 can specify which access mechanism(s) are being requested. For example, the AM request parameters may indicate one or more platforms for which access mechanism(s) are being requested (e.g., OS, device type, application editions, etc.). In a more specific example, if the link requesting device 100 is a server (e.g., an advertisement server), the link requesting device 100 can indicate one or more platforms in the AM request parameters in order to acquire the desired access mechanisms for later distribution to user devices (e.g., for advertisements).

The link generation system 102 accesses a web resource (e.g., webpage data 218) on the web server 104 based on the web URL 212 received by the link requesting device 100. For example, the link generation system 102 may make a request (illustrated as “web request 220”) for a web resource using hypertext transfer protocol (HTTP). A web resource may include data used for generating a webpage on a web browser application. Accordingly, the data retrieved from the web server 104 may be generally referred to herein as “webpage data 218.”

The link generation system 100 generates one or more access mechanism(s) 222 and link rendering data 224 based on the received webpage data 218 and other data (e.g., data included in access mechanism template records 312 and rendering records 318). The link generation system 102 transmits the access mechanism(s) 222 and/or link rendering data 224 to the link requesting device 100. The generated access mechanisms 222 may be used (e.g., by the user device 200) to access a native application state that corresponds to the webpage that was accessed using the web URL 210. The link rendering data 224 can be used (e.g., by the user device 200) to render an application link (e.g., application link 202) that represents the native application state accessed by the access mechanism(s) 222.

An access mechanism may refer to a string that includes a reference to a native application (e.g., one of the native applications 206 installed on the user device 200) and indicates one or more operations for a user device (e.g., user device 200) to perform. If a user selects an application link including an access mechanism, the user device may launch the native application referenced in the access mechanism and set the application into a state specified by the access mechanism. In some cases, access mechanisms can include application resource identifiers (e.g., defined by the application developers). Such application resource identifiers may have a format similar to a web URL schema including a domain and a path. For example, an application resource identifier for the OPENTABLE® application developed by OpenTable, Inc. may be “vnd.opentable.deeplink://opentable.com/restaurant/profile?rid=1180&refid=1.” This specific application resource identifier may cause the OPENTABLE® Android native application to launch a restaurant table reservation page for a restaurant named “The French Laundry.” In some cases, an access mechanism may include one or more operations for the user device to perform (e.g., a script) in addition to, or in place of, the application resource identifiers. Example operations may include, but are not limited to, launching a native application, waiting for the native application to start, creating and sending a search request to a server, setting a current geo-location in a native application, making a restaurant reservation, sending a text message, and adding an appointment to a calendar.

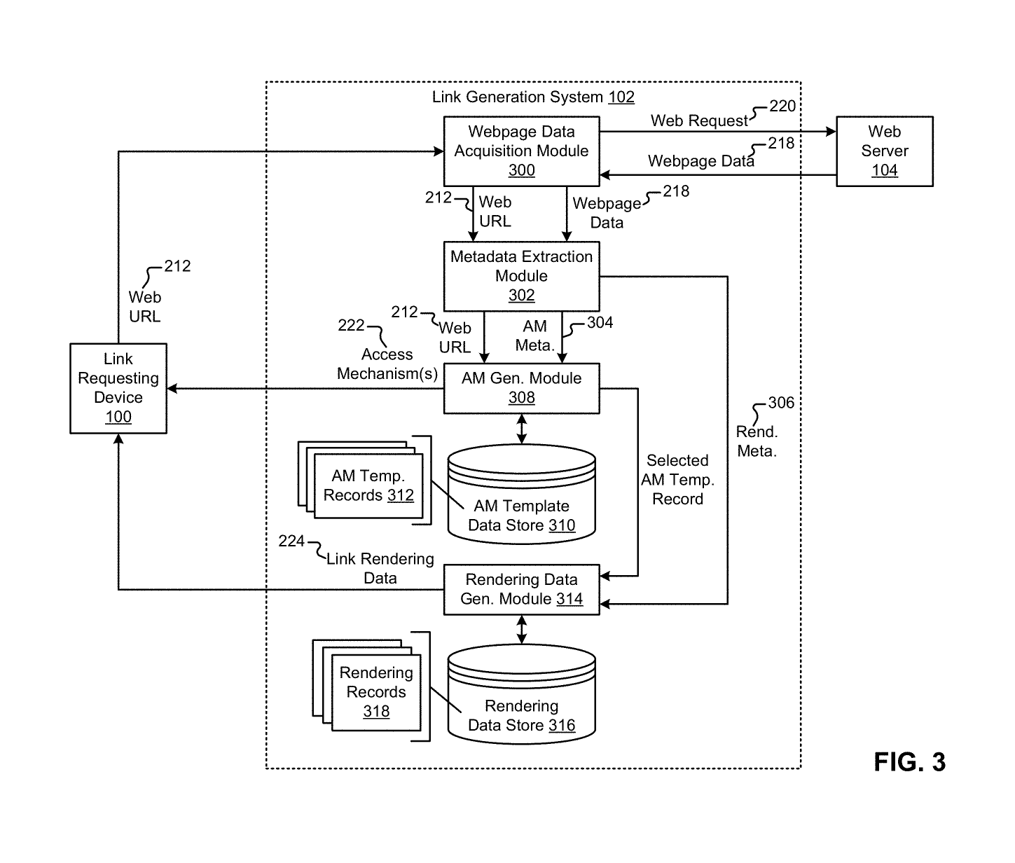

FIG. 3 illustrates an example link generation system 102. The link generation system 102 includes a webpage data acquisition module 300 (hereinafter “webpage acquisition module 300”) and a metadata extraction and processing module 302 (hereinafter “metadata extraction module 302”). The webpage acquisition module 300 receives the web URL 212 from the link requesting device 100, makes a web request 220 to a web server 104 associated with the web URL 212, and receives webpage data 218 from the web server 104. The metadata extraction module 302 generates access mechanism metadata 304 (hereinafter “AM metadata 304”) and rendering metadata 306 based on the webpage data 218.

The link generation system 102 includes an access mechanism generation module 308 (hereinafter “AM generation module 308”) and an access mechanism template data store (hereinafter “template data store 310”). The AM generation module 308 generates access mechanisms 222 based on the AM metadata 304 and access mechanism template records 312 (hereinafter “template records 312”) stored in the template data store 310. The link generation system 102 also includes a rendering data generation module 314 (hereinafter “rendering module 314”) and a rendering data store 316. The rendering module 314 generates link rendering data 224 based on the rendering metadata 306 and rendering records 318 stored in the rendering data store 316.

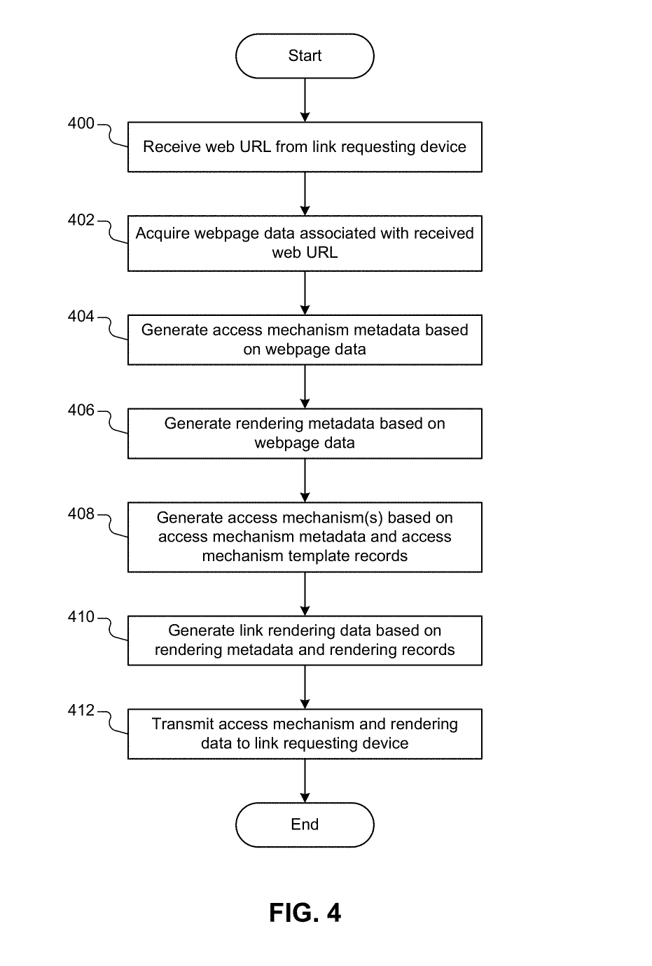

FIG. 4 illustrates a method describing operation of the link generation system 102 illustrated in FIG. 3. In block 400, the webpage acquisition module 300 receives a web URL 212 from the link requesting device 100. In block 402, the webpage acquisition module 300 acquires webpage data 218 associated with the web URL 212. In some implementations, the webpage acquisition module 300 can acquire the webpage data 218 by making a web request 220 to a web server 104 in response to receipt of the web URL 212. For example, the webpage acquisition module 300 may make the web request 220 immediately upon receiving the web URL 212 from the link requesting device 100.

In some implementations, instead of retrieving the webpage data 218 from a web server 104, the webpage acquisition module 300 may have retrieved and stored the webpage data 218 before receipt of the web URL 212. In these implementations, the webpage acquisition module 300 may be configured to retrieve webpage data for one or more web URLs (e.g., a list of web URLs) and store the retrieved webpage data in a link generation system data store (not illustrated) in the link generation system 102. In these cases, the link generation system data store may include webpage data for a plurality of webpages that the webpage acquisition module 300 is configured to crawl and scrape. In some cases, the link generation system 102 can receive webpage data based on partnerships with content owners. Accordingly, in some cases, the webpage acquisition module 300 can retrieve the webpage data from a web server 104 in response to receipt of a web URL 212. In other cases, if the link generation system data store includes stored webpage data for a received web URL, then the webpage acquisition module 300 can retrieve the webpage data from the link generation system data store in response to receipt of the web URL 212.

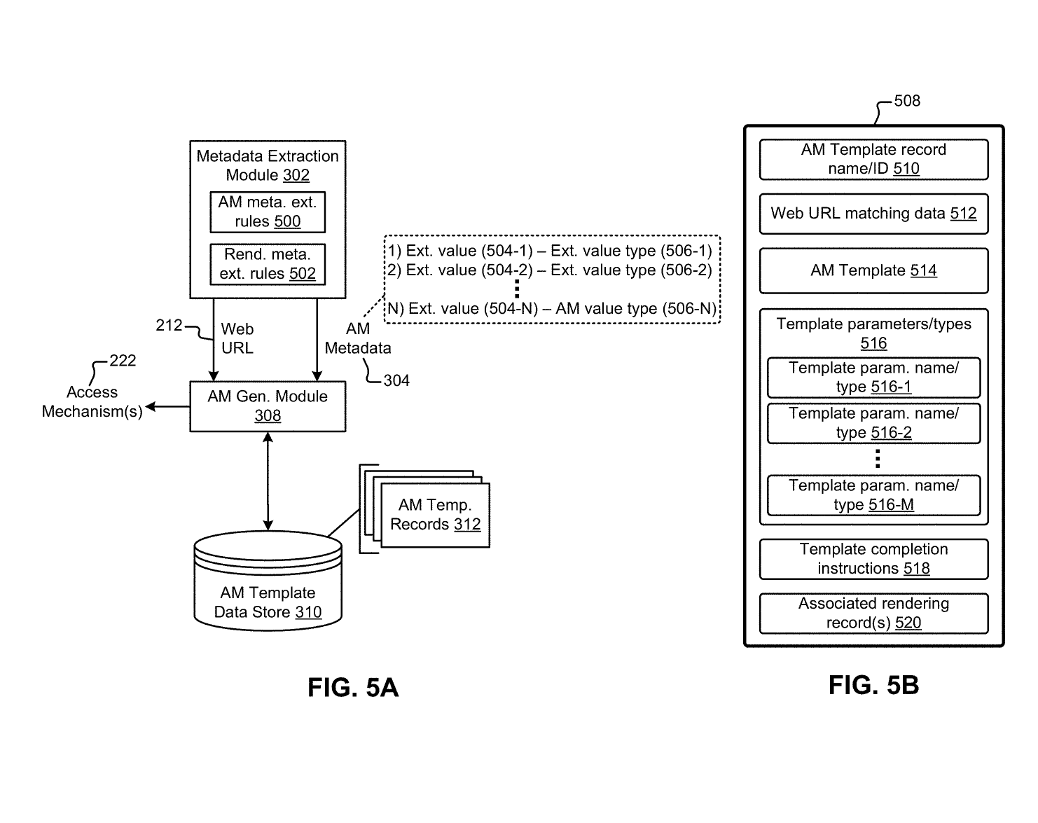

In block 404, the metadata extraction module 302 generates AM metadata 304 based on the webpage data 218. The AM metadata 304 may include extracted values (e.g., extracted values 504 of FIG. 5A), each of which is associated with an extracted value type (e.g., extracted value types 506 of FIG. 5A). Accordingly, the AM metadata 304 may include a list of extracted value/type pairs. The metadata extraction module 302 may generate the AM metadata 304 (e.g., extracted values/types) based on text or other values included in the webpage data 218. In some implementations, the metadata extraction module 302 may generate the extracted values by directly extracting the values from the webpage data 218 (e.g., without additional processing). The directly extracted values may then be used for generating access mechanisms 222. For example, the metadata extraction module 302 may extract a company stock symbol from the webpage data 218, which then can be inserted into an access mechanism template (e.g., AM template 514 of FIG. 5B) to generate the access mechanism 222. In other implementations, the metadata extraction module 302 may process the webpage data 218 to generate the extracted values. For example, the metadata extraction module 302 may transform text/numbers of the webpage data 218 into extracted values that can be used for generation of access mechanisms 222.

The metadata extraction module 302 assigns extracted value types to the extracted values. For example, if the extracted value is a stock symbol (e.g., 3 or 4 letter symbol), then the metadata extraction module 302 may assign a value type of “stock symbol” to the extracted value. If the extracted value is a city name (e.g., Chicago), then the metadata extraction module 302 may assign a value type of “city name” to the extracted value. Additional value types may include, but are not limited to, zip code, business type, and business name.

The metadata extraction module 302 can include access mechanism metadata extraction rules 500 (hereinafter “AM extraction rules 500”) that indicate which information to extract from the webpage data 218 and also how to process the extracted information. The AM extraction rules 500 may also indicate which value types to assign to the extracted values. In some implementations, the AM extraction rules 500 can be domain and path specific. For example, each of the AM extraction rules 500 can be used for a specific portion of a website (e.g., a specific path indicated in the web URL 212). In some implementations, the AM extraction rules 500 can also be application specific. In these implementations, the metadata extraction module 302 may extract and process data differently for the same web URL, depending on the native application for which the AM metadata 304 is being generated. For example, a first application may use two letter United States (U.S.) state abbreviations (e.g., IL for Illinois) and a second application uses another state abbreviation/code (e.g., The metadata extraction module 302 may then extract and/or process U.S. state information included in the webpage data 218 according to a first AM metadata extraction rule for the first application (e.g., to generate a two letter abbreviation) and a second AM extraction rule for the second application (e.g., to generate a three letter abbreviation and/or numeric code). In summary, the metadata extraction module 302 may include a plurality of AM extraction rules 500 for different web domains/paths and native applications. The metadata extraction module 302 may identify which AM extraction rule 500 to use based on the received web URL 212 and/or based on the native application(s) for which the AM extraction rule is configured.

In block 406, the metadata extraction module 302 generates rendering metadata 306 based on the webpage data 218. Rendering metadata 306 may include text and/or images used for generating link rendering data 224. Example rendering metadata 306 for a stock investment website may include text indicating a current stock price, a stock symbol, a company name, and a stock price chart. Example rendering metadata 306 for a restaurant review website may include a restaurant logo image, one or more images of items served at the restaurant, a restaurant address, phone number, and one or more restaurant reviews. Example rendering metadata 306 for a news website may include an image related to a news article, an author, and a text snippet.

The rendering metadata 306 may be directly extracted from the webpage data 218 and/or processed before generating link rendering data 224 for transmission to the link requesting device 100. For example, the metadata extraction module 302 may process text (e.g., to produce a summary) and images (e.g., format and/or compress images) for use as link rendering data 224. The metadata extraction module 302 may generate rendering metadata 306 according to rendering metadata extraction rules 502 that indicate how to generate the rendering metadata 306. For example, the rendering metadata extraction rules 502 may indicate which text/images to extract and how to format/compress the text/images for later rendering. The metadata extraction module 302 may include a plurality of different rendering metadata extraction rules 502 for different web domains/paths and native applications. The metadata extraction module 302 may identify which of the rendering metadata extraction rules to use based on the received web URL 212 and/or based on the native application(s) for which the rendering metadata extraction rule is configured.

In block 408, the AM generation module 308 generates one or more access mechanisms 222 based on the web URL 212, the AM metadata 304, and data included in the template records 312. For example, the AM generation module 308 may select an access mechanism template (e.g., AM template 514 of FIG. 5B) based on the web URL 212. Then, the AM generation module 308 may generate an access mechanism 222 by inserting extracted values into the selected access mechanism template. In block 410, the rendering module 314 generates the link rendering data 224 based on the rendering metadata 306 and data included in the rendering records 318. In some implementations, the rendering module 314 may generate the link rendering data 224 based on which template record 312 (e.g., AM template) was used to generate the access mechanism 222.

In block 412, the link generation system 102 may transmit the access mechanism 222 and the link rendering data 224 to the link requesting device 100. In cases where the link requesting device 100 is a user device, the user device may render an application link based on the received link rendering data 224. The application link may access a native application state specified by the received access mechanism 222. In cases where the link requesting device 100 is a server, the server may store the link rendering data 224 and the access mechanism 222. At a later time, the server may transmit the access mechanism 222 and/or the link rendering data 224 in response to a request from a user device.

In some implementations, the link generation system 102 can be configured to transmit an access mechanism 222 without transmitting link rendering data 224 in response to receipt of the web URL 212. In other implementations, the link generation system 102 can be configured to transmit link rendering data 224 without transmitting an access mechanism 222 in response to receipt of the web URL 212. In some implementations, the link generation system 102 may be configured to receive a link request 210 that indicates whether the link requesting device 100 is requesting one or more access mechanisms 222 and/or link rendering data 224. Put another way, the link request 210 may indicate whether an access mechanism 222 or link rendering data 224 is being requested. The link generation system 102 may transmit access mechanism(s) 222 and/or link rendering data 224 as indicated in the link request 210.

As described above, the link generation system 102 may include a link generation system data store (not illustrated) that stores retrieved webpage data 218 (e.g., acquired via crawling/scraping and/or partnerships). The link generation system 102 may generate AM metadata 304, rendering metadata 306, access mechanisms 222, and link rendering data 224 based on the stored webpage data 218. In these examples, the link generation system 102 may store the AM metadata 304, rendering metadata 306, access mechanisms 222, and link rendering data 224 in the link generation system data store and later transmit the access mechanisms 222 and/or link rendering data 224 to the link requesting device 100 in response to receipt of a web URL 212.

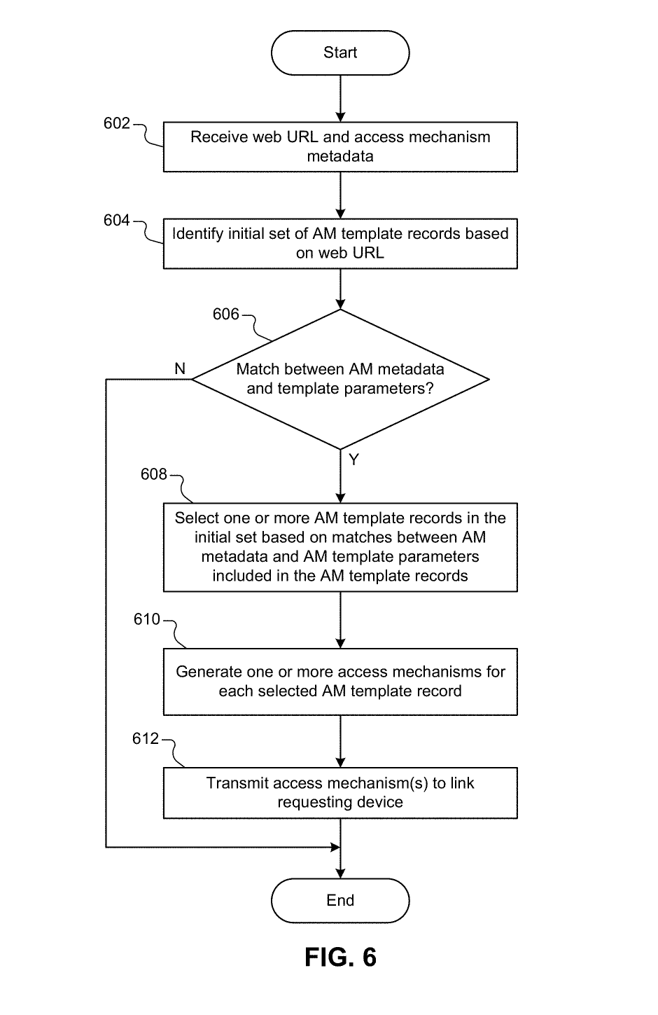

FIGS. 5A-6 illustrate operation of the AM generation module 308 with respect to template records 312. The AM generation module 308 generates one or more access mechanisms 222 using a web URL 212, AM metadata 304, and data included in template records 312. Example AM metadata 304 illustrated in FIG. 5A includes a set of extracted values 504-1, 504-2, . . . , 504-N (collectively “extracted values 504”), each of which is associated with an extracted value type 506 (e.g., 506-1, 506-2, . . . , 506-N). An example template record 508 is illustrated in FIG. 5B. FIG. 6 illustrates an example method for generating one or more access mechanisms with reference to the AM generation module 308 of FIG. 5A and the template record 508 of FIG. 5B.

FIG. 5B illustrates an example template record 508. The template data store 310 includes a plurality of template records 312 that may include similar data as example template record 508. The template record 508 includes data that the AM generation module 308 may use to select the template record 508 from the plurality of template records 312 included in the template data store 310. Additionally, the template record 508 includes data that the AM generation module 308 uses to generate an access mechanism 222. In general, the AM generation module 308 selects one or more template records and then generates the access mechanism(s) using the selected template record(s).

The template record 508 includes an AM template 514, a list of template parameters/types 516, and template completion instructions 518. The AM generation module 308 generates an access mechanism 222 using the access mechanism template 514, the extracted values 504, and the template completion instructions 518. The AM template 514 may include a string in the format of an access mechanism (e.g., in the format of an application resource identifier and/or operations). In general, the AM generation module 308 may generate the access mechanism 222 by modifying (e.g., generating) portions of the AM template 514 based on the extracted values 504.

The template completion instructions 518 may indicate how to modify the AM template 514 using the extracted values 504. In one example, the AM generation module 308 may generate an access mechanism 222 by inserting one or more extracted values 504 into the AM template 514 according to the template completion instructions 518. In another example, the AM generation module 308 may generate an access mechanism 222 by generating portions of the AM template 514 (e.g., portions of the application resource identifier and/or operations) according to the template completion instructions 518.

The template record 508 includes a set of template parameters 516-1, 516-2, . . . , 516-M (collectively “template parameters 516”) (e.g., one or more template parameters), each of which can be associated with a parameter type indicating the type (e.g., category) of the template parameter. Accordingly, the template record 508 may include a set of template parameter/type pairs 516. The set of template parameter/type pairs 516 indicate which extracted values can be used to generate an access mechanism. For example, the set of template parameters 516 can indicate which extracted values (e.g., extracted value types) are desired for generating an access mechanism. In a more specific example, if the template record 508 is for an access mechanism that accesses a native application that displays stock prices, then the template record 508 may include a template parameter having the parameter type “stock symbol,” which indicates that an extracted value of the type “stock symbol” is desired for generating an access mechanism. As described herein, the AM generation module 308 may select template records based on matches between the extracted values/types and the template parameter/types.

The AM template 514 can include placeholders for the template parameters 516 indicating where the extracted values 504 can be inserted into the AM template 514 to generate an access mechanism 222. For example, an AM template 514 may include a single template parameter which can be replaced with an extracted value to generate an access mechanism. In a specific example in which an AM template includes an application resource identifier that links to an application state of a stock market application, the AM template may include a portion in which an extracted value (e.g., a stock symbol) can be inserted into the application resource identifier to generate an access mechanism. Although an extracted value can be inserted in place of a single template parameter, in other cases, the extracted value can be used to generate multiple portions of the AM template.

The template completion instructions 518 indicate how to generate an access mechanism 222 using the AM template 514 and the extracted values 504. The AM generation module 308 can generate the access mechanism(s) 222 using the extracted values 504 and the AM template 514 according to the template completion instructions 518. In some implementations, the AM generation module 308 may directly insert the extracted values 504 into the AM template 514 (e.g., without modifying the extracted values 504) according to the template completion instructions 518. In other implementations, the AM generation module 308 may process the extracted values 504 according to the template completion instructions 518 and then insert the processed extracted values into the AM template 514 in one or more places in order to generate the access mechanism 522. Accordingly, the AM generation module 308 may insert the extracted values (e.g., either directly or processed) into the application resource identifier and/or operations included in the AM template 514 according to the template completion instructions 518. In some examples, instead of inserting extracted values 504 into portions of the AM template 514, the AM generation module 308 may generate new portions of the access mechanism included in the AM template 514 based on the extracted values 504 according to the template completion instructions 518.

The template record 508 may include an access mechanism template record name/ID 510 (hereinafter “template record name 510”). The template record name 510 may identify (e.g., uniquely identify) the template record 508 among other template records in the template data store 310. The template record name 510 can be a human readable name that is descriptive of the content and/or function associated with an access mechanism generated using AM template 514. For example, the template record name 510 may describe the application state accessed by the access mechanism (e.g., current news, restaurant reviews, etc.) or the function performed when the user device uses the access mechanism generated according to the AM template 514 (e.g., play movie, play song, make reservation, etc.). The template record name 510 may include an application name indicating the native application associated with the template record 508. For example, the template record name 510 may indicate the native application that will be accessed using the access mechanism generated according to the AM template 514.

In some cases, a single template record may include data (e.g., an AM template and template completion instructions) directed to generating an access mechanism for a single native application edition (e.g., a specific OS). In other cases, a single template record may include data (e.g., an AM template and template completion instructions) directed to generating multiple access mechanisms for different native application editions (e.g., multiple OSs). For example, the single template record may include a plurality of AM templates for different application editions and/or the same access mechanism can be used for multiple different application editions. Each native application can be associated with a variety of different template records corresponding to different aspects (e.g., content/functionality) of the native application. For example, the different template records may include data (e.g., an AM template and template completion instructions) for generating access mechanisms that access different content/functionality of the native application. In a more specific example, a media streaming application can include different template records for generating access mechanisms that access different types of content (e.g., television shows, movies, music, etc.).

The AM generation module 308 selects a set of template records (e.g., one or more of template records 312) that the AM generation module 308 may then use to generate access mechanisms 222. Initially, the AM generation module 308 selects a set of template records based on matches between the web URL 212 and the web URL matching data 512 in the template records. The set of initially selected template records is referred to herein as an “initial set of template records.”

The web URL matching data 512 may include a URL. For example, the web URL matching data 512 may include a web address that includes a domain name (e.g., www.example.com). In some examples, the web URL matching data 512 may include a domain name and a path (e.g., www.example.com/segment1/segment2/). The path may be a partial path in some cases (e.g., a file name is not included). In other cases, the path may be a complete path that includes the web resource (e.g., a file name such as an HTML file). For example, the web URL matching data 512 may be in the form of “www.example.com/segment1/segment2/filename.html.” In some cases, the scheme for the web URL matching data 512 may include http, or another scheme, such as ftp.

The AM generation module 308 may compare the web URL 212 to the web URL matching data 512 in order to determine whether there is a match between the web URL 212 and the web URL matching data 512. The AM generation module 308 may determine there is a match between the web URL 212 and the web URL matching data 512 when a portion of the web URL 212 matches the web URL matching data 512. For example, if the web URL 212 includes the same string as the web URL matching data 512, then the AM generation module 308 may detect a match. In one example, the web URL 212 may include a domain, path, and filename. In this example, the AM generation module 308 may detect a match in a variety of different ways, depending on what is included in the web URL matching data 512.

If the web URL matching data 512 indicates that a domain is sufficient for a match, then the AM generation module 308 may detect a match if the domain of the web URL 212 is the same as the domain indicated in the web URL matching data 512. If the web URL matching data 512 indicates that a domain and path are required for a match, then the AM generation module 308 may detect a match if the domain and path (e.g., a portion of the path) of the web URL 212 is the same as the domain and path indicated in the web URL matching data 512. If the web URL matching data 512 indicates that a domain, path, and filename are required for a match, then the AM generation module 308 may detect a match if the domain, path, and filename of the web URL 212 is the same as that of the web URL matching data 512. Accordingly, the amount of the web URL 212 that is sufficient for a match may vary among the different template records, depending on the contents of the web URL matching data.

After selection of the initial set of template records, the AM generation module 308 selects a template record from the initial set of template records to use for generation of the access mechanism(s) 222. The template record selected for use in generation of the access mechanism(s) 222 may be referred to herein as a “result template record.” In some implementations, the AM generation module 308 can select a single result template record. In other implementations, the AM generation module 308 can select multiple result template records for use in generating multiple access mechanisms.

The AM generation module 308 can select the result template record(s) from the initial set of template records based on matches between the AM metadata 304 (e.g., extracted values/types) and the template parameters/types 516. In general, a match between the AM metadata 304 (e.g., extracted values/types) and template parameters/types 516 may indicate that the AM generation module 308 can generate an access mechanism 222 using the AM template 514 and the AM metadata 304. In some implementations, the AM generation module 308 determines there is a match between the AM metadata 304 and the template parameters/types 516 when the extracted value types 506 of the extracted values 504 matches the parameter types of the template parameters 516.

For example, if a template record in the initial set includes a single parameter of a specific parameter type, the AM generation module 308 may select the template record as a result template record when the AM metadata includes an extracted value of the same type as the specific parameter type. If a template record includes multiple template parameters, then the AM generation module 308 may select the template record when the AM metadata includes extracted values having value types that match the parameter types of the multiple parameters. For example, if the AM metadata includes a first extracted value having a first type and a second extracted value having a second type, then the AM generation module 308 may select a template record that includes a first template parameter having the first type and a second template parameter having the second type.

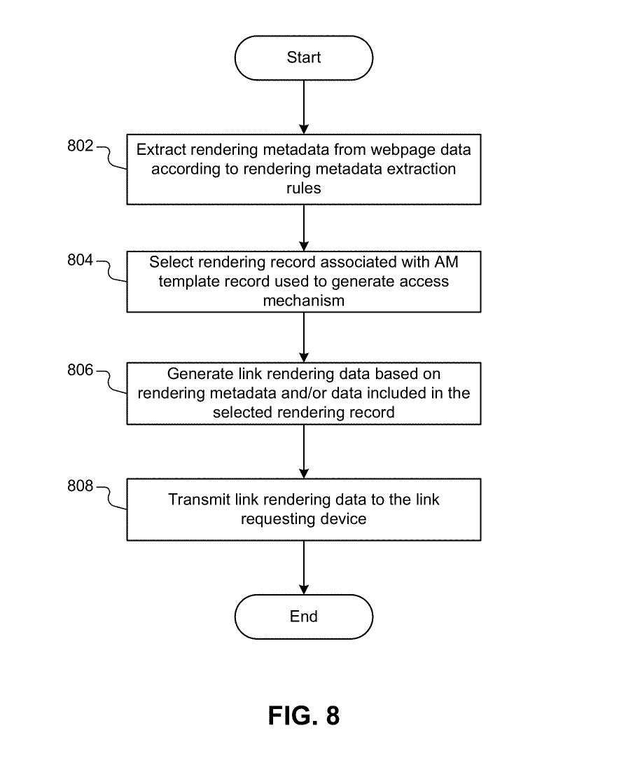

The template record 508 may include a field indicating associated rendering records 520. The associated rendering records 520 may indicate which rendering record(s) 318 in the rendering data store 316 can be used to generate link rendering data 224 that corresponds to the generated access mechanism(s) 222. The associated rendering records 318 may be used by the rendering module 314 to generate link rendering data 224 that represents the native application state accessed using the access mechanism(s) 222. The AM generation module 308 may indicate to the rendering module 314 which template record was used to generate the access mechanism(s) 222 so that the rendering module 314 may select a rendering record based on which access mechanism was generated. Rendering is described in greater detail with respect to FIGS. 7A-8.

As described herein, the link request 210 can specify which access mechanism(s) are being requested. For example, the AM request parameters 216 may indicate one or more platforms for which access mechanism(s) are being requested. In some implementations, the AM generation module 308 may filter out (e.g., refrain from transmitting) template records and/or access mechanisms that are not requested in the link request 210. For example, when selecting the initial set of template records or selecting the result template records, the AM generation module 308 may refrain from including template records associated with platforms other than those requested in the AM request parameters 216.

Put another way, the AM generation module 308 may select template records that are associated with the desired platform indicated in the AM request parameters 216. In some implementations, the template records may include platform data that indicates the platform associated with the template record. In examples where the template record can be used to generate multiple access mechanisms for different platforms, the template record can include platform data that indicates the platform for each of the multiple access mechanisms.

In some cases, webpage data 218 may include application resource identifiers (e.g., embedded within HTML files). For example, website developers may embed the application resource identifiers in the webpages. In these cases, the AM generation module 308 can extract the application resource identifiers and provide the application resource identifiers to the link requesting device 100. The AM generation module 308 may be configured to identify the platforms of the embedded application resource identifiers. The AM generation module 308 may then generate access mechanisms for platforms that are not included in the webpage data 218. For example, the AM generation module 308 may be configured to generate access mechanisms for a predetermined set of platforms. In this example, the AM generation module 308 may generate access mechanisms for platforms that are included in the predetermined set, but not included in the webpage data 218. As another example, the AM generation module 308 may generate access mechanisms for platforms that are indicated in the AM request parameters 216 if access mechanisms for the requested platforms are not included in the webpage data 218.

FIG. 6 illustrates a method for generating access mechanisms according to the present disclosure. In block 602, the AM generation module 308 receives the web URL 212 and the AM metadata 304. In block 604, the AM generation module 308 identifies an initial set of template records based on the web URL 212. In block 606, the AM generation module 308 determines whether the AM metadata 304 matches template parameters of one or more template records.

If one or more template records of the initial set include template parameters 516 (e.g., parameter types) that match the AM metadata 304 (e.g., the extracted value types 506), the AM generation module 304 may select the template records that match in block 608. The template records selected in block 608 may be referred to as result template records. The method ends in the case that the AM generation module 308 does not find a match in block 606. In block 610, the AM generation module 308 generates one or more access mechanisms 222 for each of result template records. In block 612, the link generation system 102 (e.g., the AM generation module 308) transmits the generated access mechanism(s) 222 to the link requesting device 100.

The template records 312 may be generated in a variety of different ways. In some implementations, the link generation system operator may manually generate the template records 312. In some cases, an application developer can provide data to the link generation system operator for generating the template records 312. Additionally, or alternatively, the link generation system 102 may include modules (not shown) that automatically generate components of the template records 312 (e.g., by performing static and/or dynamic analysis of native applications and/or websites). Accordingly, the template records 312 may be generated manually and/or automatically with input from a variety of different sources.

FIGS. 7A-8 illustrate operation of the rendering module 314 with respect to the rendering records 318. The rendering module 314 generates the link rendering data 224. The link rendering data 224 may include text and/or images that are formatted for display on a user device (e.g., user device 200). As described herein, in some cases, the link requesting device 100 is a user device that may render application links (e.g., application link 701 of FIG. 7A) upon receipt of the link rendering data 224. In other cases, the link requesting device 100 (e.g., part of an advertisement system) may store the received link rendering data 224 and later transmit the link rendering data 224 (e.g., as an advertisement) to the user device for rendering.

The rendering module 314 communicates with a rendering data store 316 that includes a plurality of rendering records 318. The rendering module 314 may generate the link rendering data 224 based on rendering metadata 306 and/or data included in the rendering records 318. FIG. 7B illustrates an example rendering record 700. The rendering record 700 may include a rendering record name/ID 702, rendering instructions 706, a rendering template 704, stored rendering data 708, and a field 710 indicating associated AM template records. The rendering data store 316 may include a plurality of rendering records as illustrated in FIG. 7B.

The rendering record name/ID 702 (hereinafter “rendering record name 702”) may identify (e.g., uniquely identify) the rendering record 700 among other rendering records in the rendering data store 316. The rendering record name 702 may describe attributes of the application link to be rendered based on the rendering record 700. For example, the rendering record name 702 may indicate the native application accessed by the application link. As another example, the rendering record name 702 may also indicate the content/function associated with the application link. The rendering data store 316 may include rendering records 318 for a plurality of native applications. The rendering records 318 can be directed to generating link rendering data 224 for a single native application. In these cases, the rendering data store 316 may include a plurality of different rendering records for the same native application, where each of the rendering records is directed to link rendering data for different content/functions of the native application. The rendering data store 316 may also include rendering records 318 that can be used for multiple different native applications.

The rendering template 704 may be a template that is configured to receive rendering metadata 306 (e.g., text and/or images) extracted from the webpage data 218. In general, the rendering template 704 may define the layout of an application link (e.g., text/image location), image properties (e.g., image format/size) of images to be included in the link rendering data 224, and text format (e.g., size/font).

The rendering instructions 706 may include instructions for generating link rendering data 224 based on the rendering metadata 306 and data included in the rendering record 700, such as the rendering template 704 and the stored rendering data 708. For example, the rendering module 314 may generate the link rendering data 224 by inserting rendering metadata 306 (e.g., text/images) into the rendering template 704 according to the rendering instructions 706. In some implementations, the rendering module 314 may process the rendering metadata 306 (e.g., format text/images) according to the rendering instructions 706.

In some cases, the rendering record 700 may include stored rendering data 708. The stored rendering data 708 may include text and/or images that were not extracted from the webpage data 218 in response to the web URL 212. Instead, the stored rendering data 708 may include rendering data that was stored prior to receipt of the web URL 212. For example, the stored rendering data 708 may include an application icon to be included in an application link that indicates the application associated with the application link (e.g., application icons 201, 703 of FIGS. 2 and 7). The stored rendering data 708 may also include text describing the native application and a link to the application (e.g., a link to the application home state or an about page). The rendering module 314 may insert the stored rendering data 708 into the rendering template 704 when generating the link rendering data 224.

The rendering record 700 may include one or more associated AM template record names/IDs 710 (hereinafter “template record names 710”). The template record names 710 can correspond to template records 312 included in the AM template data store 310. In implementations where the link generation system 102 is configured to deliver access mechanisms 222 and link rendering data 224 for rendering an application link, the rendering module 314 may select a rendering record to use for generating the link rendering data 224 based on the template record names 710.

For example, initially, the AM generation module 308 may indicate which template record was used to generate the access mechanism 222. The rendering module 314 can then select a rendering record having a template record name that corresponds to the template record name of the template record used to generate the access mechanism 222. The rendering module 314 can use the selected rendering record to generate the link rendering data 324 corresponding to the generated access mechanism.

The rendering records 318 may be generated in a variety of different ways. In some implementations, the link generation system operator may manually generate the rendering records 318. In some cases, an application developer can provide data to the link generation system operator for generating the rendering records 318 (e.g., images/text). Additionally, or alternatively, the link generation system 102 may include modules (not shown) that automatically generate the rendering records 318.

FIG. 8 illustrates an example method for generating link rendering data. In block 802, the metadata extraction module 302 extracts rendering metadata 306 from the webpage data 218 according to the rendering metadata extraction rules 502. In block 804, the rendering module 314 selects a rendering record to use in order to generate link rendering data 224. For example, if the AM generation module 308 generated an access mechanism 222, the rendering module 314 may select a rendering record that is associated with the template record used to generate the access mechanism 222. In block 806, the rendering module 314 generates link rendering data 224 using the rendering metadata 306 and data included in the selected rendering record. For example, the rendering module 314 may generate link rendering data 224 according to the rendering instructions 706 based on at least one of the rendering metadata 306, the rendering template 704, and the stored rendering data 708. In block 808, the link generation system 102 (e.g., the rendering module 314) transmits the link rendering data 224 to the link requesting device 100.

FIGS. 9-10 illustrate an example environment including a link generation system 102 in communication with an advertisement system 900 acting as a link requesting device. In the environment of FIGS. 9-10, an advertiser can interact with the advertisement system 900 to generate advertisements that link to native applications. For example, the advertiser can upload a web URL to the advertisement system 900, where the web URL accesses a webpage including material to be advertised (e.g., goods/services/businesses).

The advertisement system 900 receives one or more access mechanisms and/or link rendering data from the link generation system 102 generated based on the web URL. The advertisement system 900 can include the received access mechanism(s) and/or link rendering data in an application link that acts as an advertisement (e.g., for a good/service/business) on a user device 902 that opens a native application state. In the environment of FIGS. 9-10, advertisers may leverage the link generation system 102 in order to direct users to native application states that advertise products/services and/or to complete transactions within their desired native applications.

The environment includes advertiser devices 904 that may communicate with the advertisement system 900 via the network 106. Advertiser devices 904 may be computing devices used by advertisers to generate advertisement data. The advertiser devices 904 may include, but are not limited to, smart phones, tablet computers, laptop computers, desktop computers, and additional computing device form factors. Advertisers that use the advertiser devices 904 may include any party that advertises goods, services, businesses, or any other entities. For example, advertisers may include, but are not limited to, companies seeking to advertise goods and/or services, advertising agencies, and developers.

Advertisers may use the advertiser devices 904 to generate advertisement data. The advertisement system 900 may generate advertisements for the user devices 902 based on the advertisement data generated by advertisers. As described herein, advertisement data may include advertisement content and/or advertisement parameters. The advertiser devices 904 may run an application (e.g., a native or web application) that displays a GUI to the advertiser which allows the advertiser to enter advertisement data. An example GUI used to enter advertisement data is illustrated in FIG. 10. The application and GUI used by an advertiser to enter advertisement data is referred to herein as a “campaign manager 1000.”

An advertiser can enter the advertisement data into the campaign manager and then transmit the advertisement data to the advertisement system 900. The advertisement system 900 may store the advertisement data as an advertisement record in an advertisement data store (e.g., see FIG. 10). As described herein, a single advertisement record can be used to generate a single advertisement (e.g., a single application link). The advertisement data store can include a plurality of advertisement records, each of which can be generated by advertisers when setting up advertisement campaigns. The advertisement data store may include one or more advertisement records for each of a plurality of different native applications.

FIG. 10 illustrates an example campaign manager 1000 running on an advertiser device 904. The campaign manager 1000 can receive a variety of different types of advertisement data that may be stored by the advertisement system 900 as an advertisement record 1002. Example advertisement data that may be entered by the advertiser in the campaign manager 1000 and stored in the advertisement data store 1004 as an advertisement record 1002 is now described.

An advertiser may input a campaign name/ID 1006 into the campaign manager 1000 that uniquely identifies the advertisement campaign. The advertisement campaign may refer to the advertisement content and advertisement parameters entered for an advertisement (e.g., an application link). An advertiser can input advertisement content into the campaign manager. Advertisement content may include text and images to be included in an advertisement (e.g., into an application link). For example, the campaign manager may have a field for entering advertisement text and an interface element for uploading an image (e.g., a custom graphic) to be included in an advertisement.

The campaign manager 1000 may also include user interface elements that assist the advertiser in generating native application links for advertisements. For example, the campaign manager 1000 may include a field for entering a web URL. The web URL may indicate the webpage that the advertisement (e.g., application link) accesses when selected by a user. For example, the webpage may include a good/service the advertiser wishes to advertise. If the advertiser enters a web URL into the campaign manager 1000, the advertiser device may transmit the web URL to the advertisement system 900, which then may make a link request to the link generation system 102 including the web URL.

The link generation system 102 can then transmit the access mechanism and/or link rendering data to the advertising system 900, which in turn transmits the access mechanisms and/or link rendering data to the advertiser device 904. The campaign manager 1000 can indicate to the user whether an access mechanism is available (e.g., indicated at 1008). For example, the campaign manager 1000 may include an interface element (e.g., a check box) that indicates if an access mechanism is available for the web URL (e.g., a check in the box) or if the access mechanism is unavailable for the web URL (e.g., an X in the checkbox).

The campaign manager 1000 may render an application link preview 1010 that gives the advertiser a preview of an application link (e.g., the advertisement) that can be generated for a user device 902. In some cases, the campaign manager 1000 may render the application link preview 1010 using link rendering data generated by the link generation system 102. Additionally, or alternatively, the campaign manager 1000 may render the application link preview 1010 using advertisement content inserted by the advertiser in the campaign manager 1000 (e.g., the advertisement text and/or uploaded image).

The campaign manager 1000 can include user interface elements for entering advertisement parameters. Advertisement parameters may include a variety of different advertisement targeting parameters indicating when an advertisement should be displayed to a user. A targeting parameter may refer to a condition that should be satisfied before the advertisement system 900 generates an advertisement. Example advertisement targeting parameters may include, but are not limited to, keyword targeting parameters, platform targeting parameters, and geographic targeting parameters. The advertiser can specify the different targeting parameters in the campaign manager 1000.

A keyword targeting parameter may be a condition that is satisfied when one or more keywords are entered on a user device 902 by a user (e.g., in a search query). The advertiser may specify the one or more keywords in the campaign manager 1000. A platform targeting parameter may be a condition that is satisfied when the platform (e.g., operating system) of the user device 902 matches the desired platform specified by the advertiser. Example platform targeting parameters may also include conditions related to the type of user device 902 (e.g., smartphone/tablet), the application editions being used by the user device 902, and/or the web-browser running on the user device 902. A geographic targeting parameter may be a condition that is satisfied based on the location of the user device 902 in communication with the advertisement system 900.

The advertiser may specify additional advertisement parameters in the campaign manager. Additional advertisement parameters may include, but are not limited to, budget parameters and timing parameters. Example budget parameters may include a payment model such as cost per impression and/or cost per click. Another example budget parameter may include a bid price associated with the payment model, where the bid price indicates an amount paid according to the payment model (e.g. payment per impression/click). Example timing parameters may include a duration for which the advertisement campaign is to be run. For example, the duration may include start and stop dates for advertising and/or time(s) of day during which to advertise. The list of advertisement parameters included herein is not exhaustive. As such, additional or alternative advertisement parameters are contemplated.

As described above and illustrated in FIG. 10, the advertisement system 900 may store the advertisement content 1012 and the advertisement parameters 1014 for a single advertisement in an advertisement record 1002. Additionally, the advertisement record 1002 may include one or more access mechanisms 1016 generated by the link generation system 102. The advertisement system 900 may receive an advertisement request from a user device 902 or other computing device at some time subsequent to generation of the advertisement record 1002.

The advertisement request may be a request for an advertisement in the form of an application link (e.g., application link 202 of FIG. 2) for insertion into a webpage or an application state (e.g., a search page). The advertisement request may include parameters such as keywords, platform data, geographic data, or other data. In response to the advertisement request, the advertisement system 900 may determine whether the advertisement parameters (e.g., targeting parameters) of any of the advertisement records is satisfied. If the advertisement system 900 identifies an advertisement record including advertisement parameters that are satisfied, the advertisement system 900 may generate an advertisement including the advertisement content 1012 and one or more access mechanisms 1016. The advertisement system 900 may then transmit the advertisement to the computing device that generated the advertisement request.

Although the advertisement system 900 may retrieve access mechanisms from the link generation system 102 based on web URLs received via a campaign manager 1000, in some implementations, the advertisement system 900 may automatically retrieve access mechanisms from the link generation system 102 in other circumstances. For example, the advertisement system 900 may be configured to automatically retrieve access mechanisms and/or link rendering data for web URLs associated with any advertisement records including web URLs. In one example, the advertisement system 900 may be configured to automatically request an access mechanism and/or link rendering data from the link generation system 102 upon serving an advertisement. In another example, the advertisement system 900 may automatically populate existing advertisement records including web URLs with access mechanisms.

Modules and data stores included in the systems (e.g., 102, 900) represent features that may be included in the systems of the present disclosure. The modules and data stores described herein may be embodied by electronic hardware, software, firmware, or any combination thereof. Depiction of different features as separate modules and data stores does not necessarily imply whether the modules and data stores are embodied by common or separate electronic hardware or software components. In some implementations, the features associated with the one or more modules and data stores depicted herein may be realized by common electronic hardware and software components. In some implementations, the features associated with the one or more modules and data stores depicted herein may be realized by separate electronic hardware and software components.

The modules and data stores may be embodied by electronic hardware and software components including, but not limited to, one or more processing units, one or more memory components, one or more input/output (I/O) components, and interconnect components. Interconnect components may be configured to provide communication between the one or more processing units, the one or more memory components, and the one or more I/O components. For example, the interconnect components may include one or more buses that are configured to transfer data between electronic components. The interconnect components may also include control circuits (e.g., a memory controller and/or an I/O controller) that are configured to control communication between electronic components.

The one or more processing units may include one or more central processing units (CPUs), graphics processing units (GPUs), digital signal processing units (DSPs), or other processing units. The one or more processing units may be configured to communicate with memory components and I/O components. For example, the one or more processing units may be configured to communicate with memory components and I/O components via the interconnect components.

Memory components may include (e.g., store) data described herein. For example, the memory components may include the data (e.g., records) included in the data stores. Memory components may also include instructions that may be executed by one or more processing units. For example, memory may include computer-readable instructions that, when executed by one or more processing units, cause the one or more processing units to perform the various functions attributed to the modules and data stores described herein.

The I/O components may refer to electronic hardware and software that provides communication with a variety of different devices. For example, the I/O components may provide communication between other devices and the one or more processing units and memory components. In some examples, the I/O components may be configured to communicate with a computer network. For example, the I/O components may be configured to exchange data over a computer network using a variety of different physical connections, wireless connections, and protocols. The I/O components may include, but are not limited to, network interface components (e.g., a network interface controller), repeaters, network bridges, network switches, routers, and firewalls. In some examples, the I/O components may include hardware and software that is configured to communicate with various human interface devices, including, but not limited to, display screens, keyboards, pointer devices (e.g., a mouse), touchscreens, speakers, and microphones. In some examples, the I/O components may include hardware and software that is configured to communicate with additional devices, such as external memory (e.g., external HDDs).

In some implementations, the systems may include one or more computing devices that are configured to implement the techniques described herein. Put another way, the features attributed to the modules and data stores described herein may be implemented by one or more computing devices. Each of the one or more computing devices may include any combination of electronic hardware, software, and/or firmware described above. For example, each of the one or more computing devices may include any combination of processing units, memory components, I/O components, and interconnect components described above. The one or more computing devices of the systems may also include various human interface devices, including, but not limited to, display screens, keyboards, pointing devices (e.g., a mouse), touchscreens, speakers, and microphones. The computing devices may also be configured to communicate with additional devices, such as external memory (e.g., external HDDs).

The one or more computing devices of the systems may be configured to communicate with the network 106. The one or more computing devices of the systems may also be configured to communicate with one another (e.g., via a computer network). In some examples, the one or more computing devices of the systems may include one or more server computing devices configured to communicate with user devices, gather data from data sources, index data, store the data, and store other documents. The one or more computing devices may reside within a single machine at a single geographic location in some examples. In other examples, the one or more computing devices may reside within multiple machines at a single geographic location. In still other examples, the one or more computing devices of the systems may be distributed across a number of geographic locations.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. §112(f) unless an element is expressly recited using the phrase “means for” or, in the case of a method claim, using the phrases “operation for” or “step for.”

What is claimed is:

1. A computerized link generation system comprising:
a webpage data acquisition module configured to (i) receive a first web URL from a link requesting device and (ii) request webpage data from a server specified by the first web URL;
a metadata extraction module configured to extract access data and rendering data from the webpage data, wherein the extracted rendering data includes at least one text string and at least one image;
an access mechanism template data store configured to store access mechanism templates, wherein each access mechanism template includes web URL matching data and a set of parameter types;
an access mechanism generation module configured to
select one of the access mechanism templates according to a comparison between the first web URL and the web URL matching data of the access mechanism templates; and
generate a first access mechanism by populating the selected access mechanism template with the extracted access data based on a mapping of the extracted access data to the set of parameter types, wherein the first access mechanism invokes specific functionality of at least one of a native edition of an application and a web edition of an application;
a rendering data store configured to store rendering records, wherein each of the rendering records dictates how to arrange display data associated with an access mechanism;
a rendering data generation module configured to select one of the rendering records and generate link rendering data with the extracted rendering data according to the selected rendering record; and
a transmission device configured to provide the first access mechanism and the link rendering data to the link requesting device, wherein user actuation of the link rendering data on a user device is configured to invoke the first access mechanism.

2. The computerized link generation system of claim 1 wherein the one of the rendering records includes a display layout and defined locations within the layout to be populated by at least a portion of the extracted rendering data.

3. The computerized link generation system of claim 1 wherein, for each access mechanism template of the access mechanism templates, the web URL matching data includes a string.

4. The computerized link generation system of claim 3 wherein, for each access mechanism template of the access mechanism templates, the web URL matching data includes a criterion indicating how closely the string must be matched.

5. The computerized link generation system of claim 1 wherein the extracted access data includes a set of pairs, wherein each pair includes a value and a type identifier.

6. The computerized link generation system of claim 5 wherein the access mechanism generation module is configured to select the one of the access mechanism templates according to a similarity between the set of parameter types and the type identifiers of the extracted access data.

7. The computerized link generation system of claim 6 wherein the access mechanism generation module is configured to select multiple of the access mechanism templates in response to each access mechanism template of the access mechanism templates for which the set of parameter types is a subset of the type identifiers of the extracted access data.

8. The computerized link generation system of claim 1 wherein the link requesting device is one of:
the user device; and
a server configured to store the first access mechanism and the link rendering data until a request is received from the user device.

9. The computerized link generation system of claim 1 wherein the metadata extraction module is configured to selectively resize and resample the at least one image.

10. The computerized link generation system of claim 1 wherein the first access mechanism is a string.

11. The computerized link generation system of claim 1 wherein:
the access mechanism template data store is configured to store access mechanism templates is configured to store extraction rules;
each of the extraction rules corresponds to a respective native application and specifies a format for at least one type of data for the respective native application; and
the metadata extraction module is configured to extract the rendering data from the webpage data according to at least one of the stored extraction rules.

12. A method of computerized link generation comprising:
receiving a first web URL from a link requesting device;
requesting webpage data from a server specified by the first web URL;
extracting access data and rendering data from the webpage data, wherein the extracted rendering data includes at least one text string and at least one image;
storing access mechanism templates, wherein each access mechanism template includes web URL matching data and a set of parameter types;
selecting one of the access mechanism templates according to a comparison between the first web URL and the web URL matching data of the access mechanism templates;
generating a first access mechanism by populating the selected access mechanism template with the extracted access data based on a mapping of the extracted access data to the set of parameter types, wherein the first access mechanism invokes specific functionality of at least one of a native edition of an application and a web edition of an application;
storing rendering records, wherein each of the rendering records dictates how to arrange display data associated with an access mechanism;
selecting one of the rendering records and generate link rendering data with the extracted rendering data according to the selected rendering record; and
providing the first access mechanism and the link rendering data to the link requesting device, wherein user actuation of the link rendering data on a user device is configured to invoke the first access mechanism.

13. The method of claim 12 wherein the one of the rendering records includes a display layout and defined locations within the layout to be populated by at least a portion of the extracted rendering data.

14. The method of claim 12 wherein, for each access mechanism template of the access mechanism templates, the web URL matching data includes a string.

15. The method of claim 14 wherein, for each access mechanism template of the access mechanism templates, the web URL matching data includes a criterion indicating how closely the string must be matched.

16. The method of claim 12 wherein the extracted access data includes a set of pairs, wherein each pair includes a value and a type identifier.

17. The method of claim 16 wherein the selecting the one of the access mechanism templates is performed according to a similarity between the set of parameter types and the type identifiers of the extracted access data.

18. The method of claim 17 further comprising selecting multiple of the access mechanism templates in response to each access mechanism template of the access mechanism templates for which the set of parameter types is a subset of the type identifiers of the extracted access data.

19. The method of claim 12 further comprising selectively resizing and resampling the at least one image.

20. The method of claim 12 further comprising storing extraction rules, wherein each of the extraction rules corresponds to a respective native application and specifies a format for at least one type of data for the respective native application, wherein the extracting the rendering data is performed according to at least one of the extraction rules.

21. A computer-readable medium comprising instructions for execution on processing hardware, the instructions including:
receiving a web uniform resource locator (URL) from a link requesting device, the web URL specifying a location of a web resource that is accessible via a web browser application;
retrieving webpage data from the web resource using the web URL;
generating access mechanism metadata from the webpage data, the access mechanism metadata including a list of extracted values, each of which is associated with an extracted value type that indicates the type of the extracted value;
identifying an initial set of template records in a template data store based on the web URL, each of the template records including an access mechanism template having a set of template parameters, wherein each template parameter is associated with a respective template parameter type, wherein each of the template records further includes template completion instructions indicating how to generate an application access mechanism from the access mechanism template, and wherein the application access mechanism accesses a native application state including content corresponding to the web resource;
selecting a template record from the initial set of template records based on matches between the extracted value types and the template parameter types included in the selected template record;
generating an application access mechanism using the extracted values and the access mechanism template and template completion instructions included in the selected template record;
generating link rendering data based on the webpage data, wherein the link rendering data represents the native application state accessed using the generated application access mechanism, and wherein the link rendering data is formatted for display on a user device; and
transmitting the generated application access mechanism and the link rendering data to the link requesting device.
